(19) United States
(12) Patent Application Publication
(10) Pub. No.: US 2020/0151778 A1
(43) Pub. Date: May 14, 2020

(54) MATCHING SUPPORT DEVICE, MATCHING SUPPORT SYSTEM, AND MATCHING SUPPORT METHOD

(71) Applicant: HITACHI, LTD., Tokyo (JP)

(72) Inventors: Takuya NAKAMURA, Tokyo (JP); Mamoru SAKAMOTO, Tokyo (JP); Masahiro TAKESHIMA, Tokyo (JP)

(21) Appl. No.: 16/631,872

(22) PCT Filed: Jul. 17, 2018
(86) PCT No.: PCT/JP2018/026781

§ 371 Date: Jan. 17, 2020

(30) Foreign Application Priority Data
Jul. 27, 2017 (JP) 2017-145183

(51) Int. Cl. G06Q 30/02; B29C 64/386

(52) U.S. Cl. CPC G06Q 30/0283; B33Y 80/00; B29C 64/386

(57) ABSTRACT

Provided is a matching support system including a matching support device, which includes a storage device storing predetermined conditions specified for an output of a molded object by each of an agency of the output of the molded object, a provider of 3D printer data, and an end user wanting the molded object that are parties of an output business of the molded object by a 3D printer, and a computing device comparing each condition of the party at least based on the respective contents of the molded object, the 3D printer, and cost which are specified under a condition of the end user, using the 3D printer data necessary for the output of the molded object, specifying the agency satisfying the condition of the end user, and outputting information on the agency to a predetermined device.

### TECHNICAL FIELD

The present invention relates to a matching support device, a matching support system, and a matching support method.

### BACKGROUND ART

Cases of using 3D printers to perform operations such as outputting various molded objects and incorporating the molded objects into various products and semi-finished products are being seen widely. On the other hand, an introduction cost of a high-performance 3D printer that can perform high-precision molding on complex shapes using difficult-to-process materials is considerably high. For this reason, output agencies that output molded objects with such a high-performance 3D printer on behalf of users have also appeared.

As a technology related to the output work by such a 3D printer, for example, there has been proposed an information processing device (refer to PTL 1) or the like that reads delivery management database information that stores a physical distribution base including a 3D printer associated with delivery destination information based on the delivery destination information included in delivery instruction information input from a user, specifies a plurality of neighboring physical distribution bases that indicate neighbors of the delivery destination, calculates an output time required to output molded objects using 3D printers included in the neighboring physical distribution bases using 3D model data including three-dimensional positional information indicating shapes of the molded objects input to the 3D printers included in the delivery instruction information, calculates an output completion time of the molded objects by the 3D printers from an available start time and the output time included in an operation states of the 3D printers included in the neighboring physical distribution bases, reads and acquires, from an operation state database, a delivery start time and a delivery possible time zone of delivery means included in the neighboring physical distribution bases and setting the delivery destination as a delivery area, and includes a physical distribution base determination unit that determines the physical distribution base as a physical distribution base outputting and delivering the molded objects when the delivery start time is after the output completion time and the delivery possible time zone indicates that the molded objects can be delivered at a delivery time specified by the user included in the delivery instruction information.

### CITATION LIST

### Patent Literature

PTL 1: JP 53838187 B2

### SUMMARY OF INVENTION

### Technical Problem

There are various types of 3D printers included in the above-described output agencies, and furthermore, a shape, a material, finishing accuracy, a delivery date, a budget, and the like of a molded object desired by a user are also diverse. In the first place, there are cases in which presence or absence of 3D data necessary for outputting the molded object desired by the user is uncertain. Therefore, it is difficult to specify an appropriate combination between parties in consideration of each condition associated with the output of the molded object. In addition, there is the environment where the 3D data used to output the molded object are not appropriately handled and it was difficult for a data creator to provide the molded output to the output agency.

Accordingly, an object of the present invention is to provide a technique for efficiently executing matching between parties involved in an output business of a molded object by a 3D printer while accurately considering each condition between the parties.

### Solution to Problem

A matching support device according to a preferred mode of the present invention that solves the above-described problems includes: a storage device which stores predetermined conditions specified for an output of a molded object by each of an agency of the output of the molded object, a provider of 3D printer data, and an end user wanting the molded object that are parties of an output business of the molded object by a 3D printer; and a computing device which compares each condition of the party at least based on the respective contents of the molded object, the 3D printer, and cost which are specified under a condition of the end user, uses the 3D printer data necessary for the output of the molded object, specifies the agency satisfying the conditions of the end user, and outputs information on the agency to a predetermined device.

A matching support system according to another preferred mode of the present invention includes a matching support device which includes a storage device storing predetermined conditions specified for an output of a molded object by each of an agency of the output of the molded object, a provider of 3D printer data, and an end user wanting the molded object that are parties of an output business of the molded object by a 3D printer, and a computing device comparing each condition of the party at least based on the respective contents of the molded object, the 3D printer, and cost which are specified under a condition of the end user, using the 3D printer data necessary for the output of the molded object, specifying the agency satisfying the conditions of the end user, and outputting information on the agency to a predetermined device.

A matching support method according to still another preferred mode of the present invention includes: allowing an information processing device including a storage device which stores predetermined conditions specified for an output of a molded object by each of an agency of the output of the molded object, a provider of 3D printer data, and an end user wanting the molded object that are parties of an output business of the molded object by a 3D printer to compare each condition of the party at least based on the respective contents of the molded object, the 3D printer, and cost which are specified under a condition of the end user, use the 3D printer data necessary for the output of the molded object, specify the agency satisfying the conditions of the end user, and output information on the agency to a predetermined device.

### Advantageous Effects of Invention

According to the present invention, it is possible to efficiently execute the matching between the parties involved in the output business of the molded object by the 3D printer while accurately considering each condition between the parties.

### BRIEF DESCRIPTION OF DRAWINGS

FIG. 1 is a diagram illustrating a configuration example of a network of a matching support system according to the present embodiment.

FIG. 2 is a diagram illustrating a configuration example of a data management server according to the present embodiment.

FIG. 3 is a diagram illustrating a sequence example of a matching support method according to the present embodiment.

FIG. 4 is a diagram illustrating screen example 1 according to the present embodiment.

FIG. 5 is a diagram illustrating a data configuration example of a 3D data DB according to the present embodiment.

FIG. 6 is a diagram illustrating screen example 2 according to the present embodiment.

FIG. 7 is a diagram illustrating a configuration example of an output agency DB according to the present embodiment.

FIG. 8 is a diagram illustrating screen example 3 according to the present embodiment.

FIG. 9 is a diagram illustrating screen example 4 according to the present embodiment.

FIG. 10 is a diagram illustrating a data configuration example of an end user DB according to the present embodiment.

FIG. 11 is a diagram illustrating flow example 1 of a matching support method according to the present embodiment.

FIG. 12 is a diagram illustrating flow example 2 of the matching support method according to the present embodiment.

FIG. 13 is a diagram illustrating a data configuration example of an order content DB according to the present embodiment.

FIG. 14 is a diagram illustrating flow example 3 of the matching support method according to the present embodiment.

FIG. 15 is a diagram illustrating flow example 4 of the matching support method according to the present embodiment.

FIG. 16 is a diagram illustrating flow example 5 of the matching support method according to the present embodiment.

FIG. 17 is a diagram illustrating flow example 6 of the matching support method according to the present embodiment.

FIG. 18 is a diagram illustrating notification screen example 1 according to the present embodiment.

FIG. 19 is a diagram illustrating notification screen example 2 according to the present embodiment.

FIG. 20 is a diagram illustrating notification screen example 3 according to the present embodiment.

FIG. 21 is a diagram illustrating notification screen example 4 according to the present embodiment.

### DESCRIPTION OF EMBODIMENTS

———System Configuration———

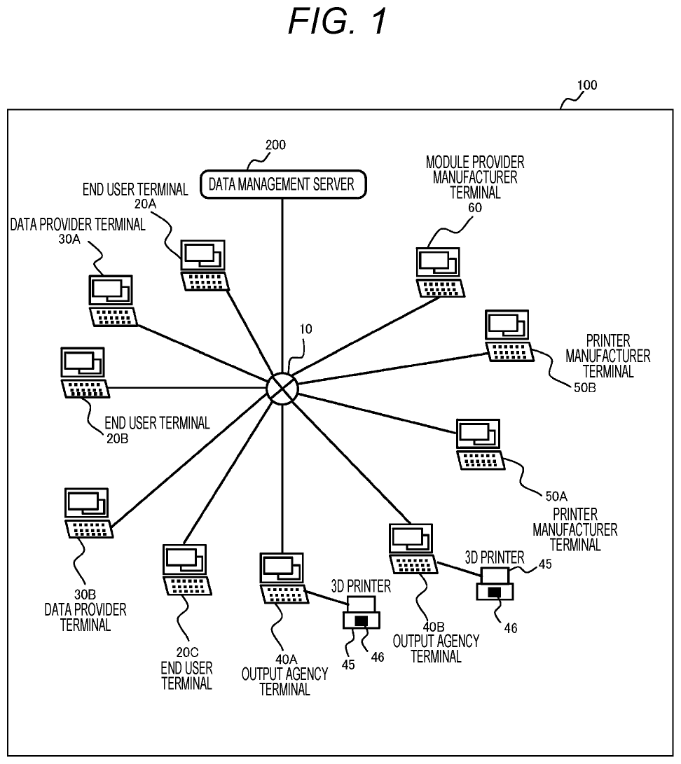

Embodiments of the present invention will be described below in detail with reference to the drawings. FIG. 1 is a configuration diagram of a network including a matching support system 100 according to the present embodiment. The matching support system 100 illustrated in FIG. 1 is a computer system which efficiently executes matching between parties involved in an output business of a molded object by a 3D printer while accurately considering each condition between the parties.

The matching support system 100 according to the present embodiment is configured to include a data management server 200, which is a matching support device, end user terminals 20A to 20C, data provider terminals 30A and 30B, output agency terminals 40A and 40B, a module provider manufacturer terminal 60, and printer manufacturer terminals 50A and 50B which are communicably connected to each other via a network 10.

An end user is an end user who obtains information on an output agency of a suitable molded object using a matching support service by the data management server 200 and obtains the molded object from the output agency. Therefore, the end user terminals 20A to 20C are the end user terminal. In the example of FIG. 1, the end user terminals 20A to 20C are assumed as terminals of three end users, but the number of end users and the number of end user terminals may be of course set arbitrarily. In this specification, the end user terminals 20A to 20C are collectively referred to an end user terminal 20.

In addition, a data provider is a person who provides 3D printer data necessary for outputting molded objects by a 3D printer. A data provider terminal is the data provider terminals 30A and 30B. The data provider operates its own terminal among the data provider terminals 30A and 30B, and uploads the 3D printer data to the data management server 200. In the example of FIG. 1, the data provider terminals 30A and 30B are assumed as terminals of each of the two data providers, but the number of data providers and the number of data provider terminals may be of course set arbitrarily. In this specification, the data provider terminals 30A and 30B are collectively referred to a data provider terminal 30.

In addition, an output agency is a provider that uses the 3D printer data provided from the above-described data provider terminal 30 to output molded objects according to an order from the end user under control by a module 46 (which will be described below in detail) in a 3D printer 45. In the example of FIG. 1, the output agency terminals 40A and 40B are assumed as terminals of each of the two output agencies, but the number of output agencies and the number of output agency terminals may be of course set arbitrarily. In this specification, the output agency terminals 40A and 40B are collectively referred to an output agency terminal 40.

In addition, a printer manufacturer is a manufacturer who sells the above-described 3D printer 45 to the above-described output agency. In the example of FIG. 1, the printer manufacturer terminals 50A and 50B are assumed as terminals of each of the two printer manufacturers, but the number of printer manufacturers and the number of printer manufacturer terminals may be of course set arbitrarily. In this specification, the printer manufacturer terminals 50A and 50B are collectively referred to a printer manufacturer terminal 50.

In addition, the module provider manufacturer is an operator who provides the printer manufacturer with the module 46 mounted on the above-described 3D printer 45. In the example of FIG. 1, the module provider manufacturer terminal 60 is assumed as a terminal of one module provider manufacturer, but the number of module provider manufacturers and the number of module provider manufacturer terminals may be of course set arbitrarily.

Note that the above-described module 46 is distributed from the module provider manufacturer terminal 60 to the printer manufacturer terminal 50 and installed in the 3D printer 45 of the printer manufacturer. This module 46 is a program created and provided by a module provider manufacturer, and includes a function for decrypting encrypted 3D printer data, a control function for outputting molded objects by a specified number of times, and a function of erasing the 3D printer data after the molded objects are output by the specified number of times. Such a module 46 is distributed from the module provider manufacturer terminal 60 to the printer manufacturer terminal 50 and installed in the 3D printer 45 of the printer manufacturer terminal 50. Of course, it may be assumed that a computer unit in which the program is installed is incorporated in the 3D printer 45 as a module instead of being provided as a program.

The end user terminal 20, the data provider terminal 30, and the output agency terminal 40 described above transmit various data related to the output of the molded object by the 3D printer 45 to the data management server 200 in advance and register the transmitted data. On the other hand, the data management server 200 executes matching process (described later) using a predetermined algorithm between data (conditions) obtained from each terminal in this way.

———Hardware Configuration———

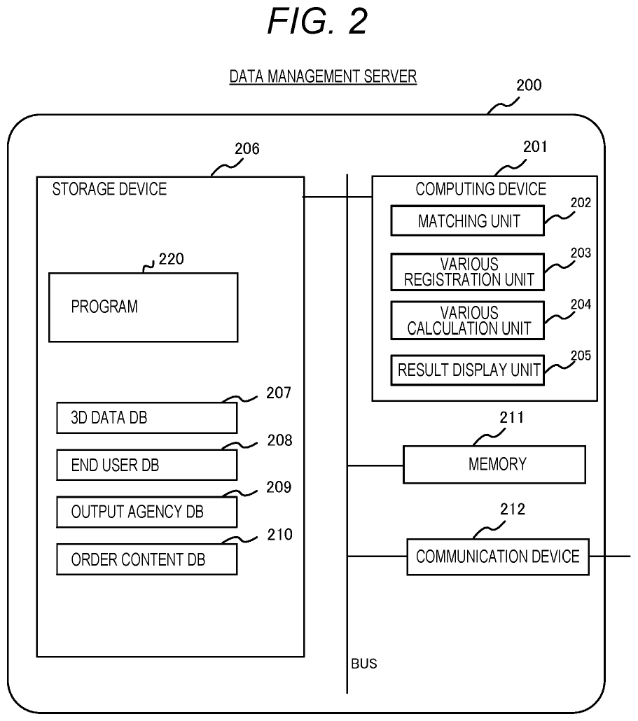

FIG. 2 is a diagram illustrating a configuration example of the data management server 200 according to the present embodiment. The data management server 200 according to the present embodiment at least includes a computing device 201 such as a CPU, a storage device 206 constituted by appropriate non-volatile storage elements such as a solid state drive (SSD) or a hard disk drive, and a memory 211 constituted by volatile storage elements such as RAM, and a communication device 212 connected to the network 10 and responsible for communication processing with other devices. Among them, the computing device 201 performs operations such as reading and the like a program 220 stored in the storage device 206 into the memory 211, and is mounted with each function unit (matching unit 202, various registration unit 203, various calculation unit 204, and result display unit 205) to perform various determination, computation, and control processing while performing integrated control on the devices themselves.

In addition to the configuration described above, the data management server 200 may further include an input device which accepts a key input or a voice input from a user or an output device such as a display which performs a display of data processing

Among the function units mounted by the above-described program 220, the matching unit 202 is provided with 3D printer data necessary for outputting a molded object desired by an end user from a data provider (stored in a 3D data DB 207 of the data management server 200), and specifies an output agency satisfying all conditions (the information is stored in an end user DB 208) specified by the end user regarding the output of the molded object based on each information of the above-described DBs 207 to 209.

Further, the various registration unit 203 accepts an input of all the conditions regarding the output of molded object from the data provider terminal 30, the output agency terminal 40, and the end user terminal 20, and registers the accepted input in the corresponding DB in the storage device 206.

In addition, the various calculation unit 204 calculates a fee paid by the end user for the output of the desired molded object or a scheduled delivery date of the molded object based on information on the output agency (information on the output agency DB 209), information on the 3D printer data (information on the 3D data DB 207), or the like.

In addition, the result display unit 205 outputs the results of the matching unit 202 and the various calculation unit 204 described above to, for example, the end user terminal 20 and displays the results.

In any case, details of each processing performed by each function unit described above will be described below with reference to FIGS. 13 to 15.

The storage device 206 stores the 3D data DB 207 (stores information on the 3D printer data acquired from the data provider terminal 30), the end user DB 208 (stores information on the molded object desired by the end user and the number of times of output or a desired fee of the molded object, and a desired delivery date), the output agency DB 209 (stores information on a 3D printer data output service that the output agency can provide), and an order content DB 210 (by executing the matching support method, the output agency is specified for the molded object desired by the end user, and confirmed order information is stored), in addition to the program 220 for mounting the functions required as the matching support device of the present embodiment.

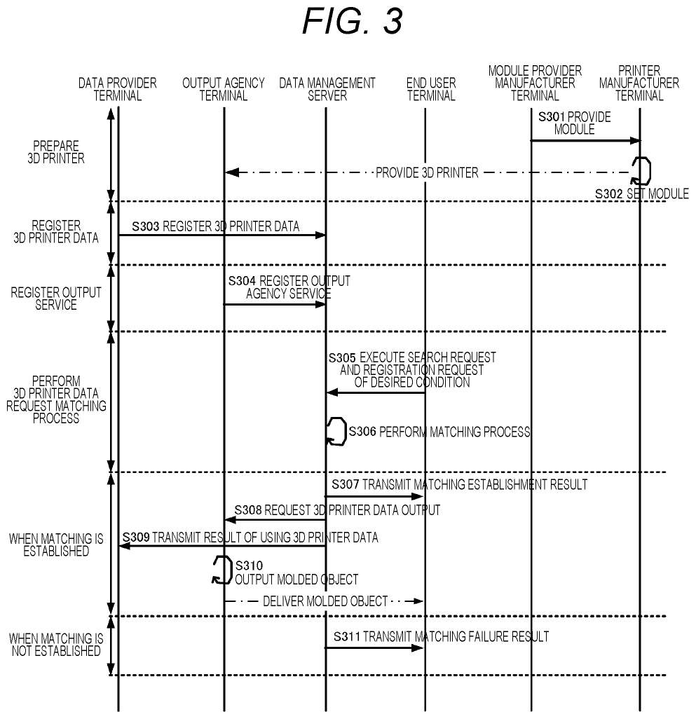

All of the information stored in each DB is used for each process illustrated in FIGS. 3 to 17 In addition, details of each DB will be described below with reference to FIGS. 10 to 13, respectively.

### SEQUENCE EXAMPLE

Hereinafter, the actual procedure of the matching support method according to the present embodiment will be described with reference to the drawings. Various operations corresponding to the matching support method described below are realized by a program that at least the data management server 200 among the devices constituting the matching support system 100 reads into the memory or the like and executes. This program is configured from a code for performing various operations described below.

FIG. 3 is a diagram illustrating a sequence example of the matching support method according to the present embodiment. Here, a processing sequence among the data management server 200, the end user terminal 20, the data provider terminal 30, the output agency terminal 40, the printer manufacturer terminal 50, and the module provider manufacturer terminal 60 is illustrated.

The data provider terminal 30 illustrated here indicates a terminal which provides the data management server 200 with the 3D printer data created and stored in advance. In addition, the output agency terminal 40 indicates a terminal which provides an output service of the molded object based on the 3D printer data provided from the data management server 200. Further, the data management server 200 indicates a server which executes the matching support method according to the present embodiment based on the information on the end user or the 3D printer data that can be provided and the information on the output service of the molded object which are obtained from the end user terminal 20, the data provider terminal 30, and the output agency terminal 40. Further, the end user terminal 20 refers to a terminal that requests the output agency terminal 40 to output the molded object. In addition, the module provider manufacturer terminal 60 indicates a module which provides the printer manufacturer terminal 50 with the module 46 mounted on the 3D printer 45. In addition, the printer manufacturer terminal 50 indicates a terminal which mounts the module 46 provided by the module provider manufacturer terminal 60 on the 3D printer 45.

Here, the output agency needs to prepare the 3D printer 45 for outputting molded objects based on the 3D printer data in advance. Therefore, the module provider manufacturer terminal 60 distributes the module 46 to the printer manufacturer terminal 50 (S301).

The module 46 distributed by the module provider manufacturer terminal 60 includes a function for decrypting encrypted 3D printer data, a control function for outputting molded objects by a specified number of times, and a function of erasing the 3D printer data after the molded objects are output by the specified number of times.

Next, the printer manufacturer terminal 50 accepts the module 46 distributed from the module provider manufacturer terminal 60 and installs the accepted module 46 in the 3D printer 45 (S302). Thus, the 3D printer 45 in which the module 46 is set is provided to the output agency with a sales contract. By doing so, the output agency which obtains the 3D printer 45 can perform molding based on the 3D printer data.

On the other hand, the data provider terminal 30 transmits and registers the 3D printer data created by a predetermined person in charge and the like to and in the data management server 200 together with the usage conditions of the 3D printer data (S303).

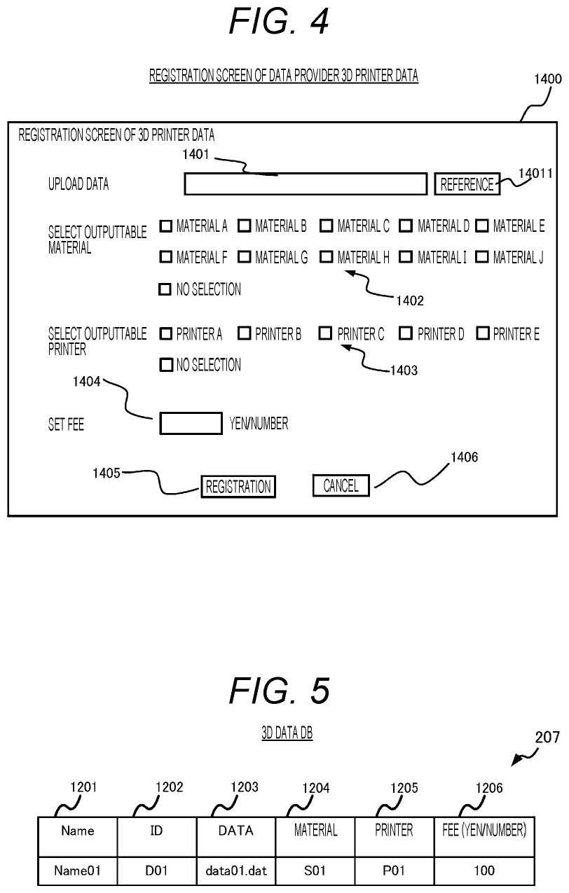

At this time, the data management server 200 transmits a registration screen 1400 illustrated in FIG. 4 to the above-described data provider terminal 30, and accepts the registration of the 3D printer data via the registration screen 1400. In this registration screen 1400, the data provider operating the data provider terminal 30 can register the 3D printer data and the output conditions or usage fees so as to be uploaded to and registered in the data management server 200.

Such a registration screen 1400 includes a form 1401 for displaying the information on the 3D printer data to be provided, and a reference button 14011 for accepting an operation such as a search of the 3D printer data. In this case, when the data provider presses the reference button 14011, the data provider terminal 30 accepts this, refers to a storage folder of the 3D printer data in the storage device and the like, displays a list of the 3D printer data separately, accepts a predetermined selection operation by the data provider, and displays the information on the 3D printer data on the form 1401.

In addition, the registration screen 1400 includes a check box 1402, which accepts the selection of the data provider for materials that can be used for molding by the 3D printer data to be registered. In this check box 1402, each material is displayed by default. If the data provider does not specify materials that can be output, a check box of “No selection” is checked. That is, the material selection in the check box 1402 is not essential but optional.

In addition, the registration screen 1400 includes a check box 1403, which accepts the selection of the data provider for the 3D printer that can be used to output the molded object based on the 3D printer data to be registered. In this check box 1403, each 3D printer is displayed by default. If the data provider does not specify the 3D printer that can be output, a check box of “No selection” is checked.

In addition, the registration screen 1400 includes an input field 1404, which accepts an input from the data provider regarding the usage fee of the 3D printer data to be registered. In this input field 1404, the input of the usage fee is accepted every time one molded object is output based on the 3D printer data to be registered.

In addition, the registration screen 1400 also includes a registration button 1405, which accepts an instruction to register the contents input and selected in the form 1401, the check box 1402, the check box 1403, and the input field 1404 described above in the data management server 200. By pressing the registration button 1405 by the data provider, the contents accepted on the registration screen 1400 are transmitted from the data provider terminal 30 to the data management server 200 and registered in the 3D data DB 207.

In addition, the registration screen 1400 also includes a cancel button 1406, which accepts an instruction to clear the contents input and selected in the form 1401, the check box 1402, the check box 1403, and the input field 1404 described above. By pressing the cancel button 1406 by the data provider, the data provider terminal 30 clears the contents accepted on the registration screen 1400 in the form 1401, the check box 1402, the check box 1403, and the input field 1404.

The contents registered through the registration screen 1400 include the 3D printer data, the type of materials used to output the 3D printer data, the type of 3D printers used to output the 3D printer data, and the usage fee of the 3D printer data.

When the data provider terminal 30 registers the above-described 3D printer data in the data management server 200, it is assumed that the data provider terminal 30 is connected to the data management server 200 via https communication to perform data upload. Further, the 3D printer data transmitted to the data management server 200 in this way is encrypted with an encryption key (for example, public key of the output agency) and stored in the 3D data DB 207.

FIG. 5 illustrates a data configuration example of the 3D data DB 207 according to the present embodiment. The 3D data DB 207 is an aggregate of records including the contents accepted from the data provider on the above-described registration screen 1400 as information.

Specifically, the 3D data DB 207 uses a name 1201 and a user ID 1202 of the data provider as keys and is an aggregate of records associated with each value of a 3D printer data 1203 provided by the data provider, a name 1204 of a material suitable for the output of the 3D printer data, a name 1205 of the 3D printer 45 suitable for the output of the 3D printer data, and a usage fee 12061 collected every time one molded object is output based on the 3D printer data.

Return to the description of the sequence of FIG. 3. On the other hand, the output agency terminal 40 registers information on the output agency service of the molded object in the data management server 200 (S304). In this sequence, the execution order of S303 and S304 described above does not matter.

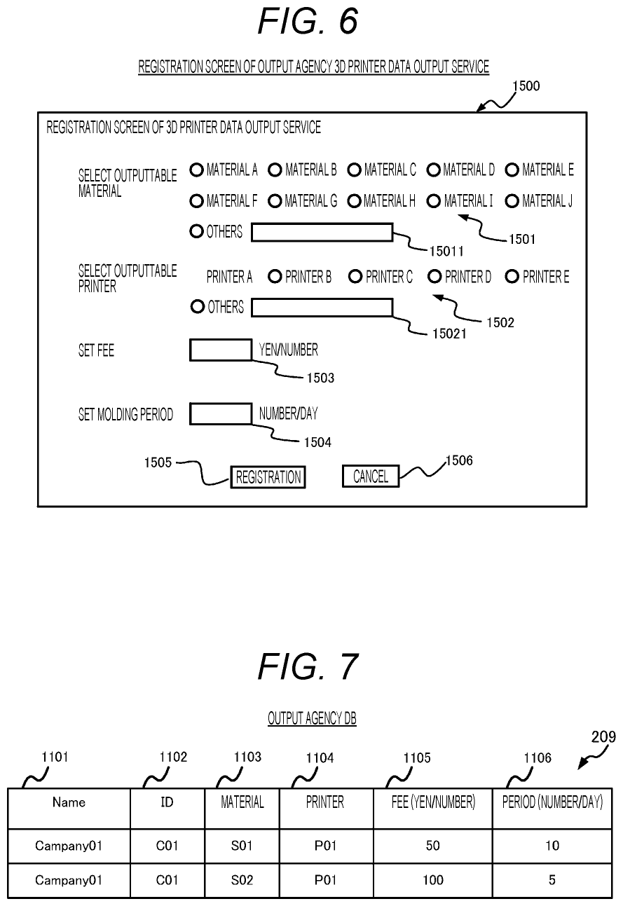

At this time, the data management server 200 transmits a registration screen 1500 illustrated in FIG. 6 to the above-described output agency terminal 40, and accepts the information on the output agency service via the registration screen 1500.

In such a registration screen 1500, the contents to be accepted for registration are information such as a type of one or more 3D printers 45 provided in the output agency, a type of materials that can be used to output the molded object in each of the one or more 3D printers 45, a fee for outputting one molded object, and the number of molded objects that can be output per unit period such as 1 day.

FIG. 6 illustrates a specific example of the above-described registration screen 1500. This registration screen 1500 includes a check box 1501 for accepting selection regarding materials that can be used to output the molded object based on the 3D printer data. In this check box 1501, each material is displayed by default. In addition, when the molding is possible using a material other than the material displayed by default, the person in charge or the like of the output agency selects “Other” and inputs the material name to an input form 15011.

In addition, the registration screen 1500 includes a check box 1502, which accepts the selection of the 3D printer 45 that can be used to output the molded object based on the 3D printer data. In this check box 1502, each 3D printer is displayed by default. In addition, when the molding is possible using a material other than the 3D printer displayed by default, the person in charge or the like of the output agency selects “Other” and inputs a model name of the 3D printer to an input form 15021.

In addition, the registration screen 1500 includes an input form 1503, which accepts an input of a fee for outputting one molded object by a combination of an outputtable material and an outputtable printer selected in the above-described check box 1501 and check box 1502 by the output agency.

In addition, the registration screen 1500 includes an input form 1504, which accepts a maximum number of inputs per day that can output the molded objects by the combination of the outputtable material and the outputtable printer selected in the above-described check box 1501 and check box 1502 by the output agency.

In addition, the registration screen 1500 includes a registration button 1505, which accepts an instruction to register the contents input and selected in the check box 1501, the check box 1502, the input form 1503, and the input form 1504 described above in the data management server 200. By pressing the registration button 1505 by the persons in charge of the output agency, the output agency terminal 40 transmits the contents input and selected in the check box 1501, the check box 1502, the input form 1503, and the input form 1504 described above to the data management server 200 and registers the transmitted contents in the output agency DB 209.

In addition, the registration screen 1500 includes a cancel button 1505, which accepts an instruction to clear the contents accepted and selected in the check box 1501, the check box 1502, the input form 1503, and the input form 1504 described above in the registration screen 1500. By pressing the cancel button 1506 by persons in charge of the output agency, the output agency terminal 40 clears the contents accepted on the registration screen 1500 in the check box 1501, the check box 1502, the input form 1503, and the input form 1504.

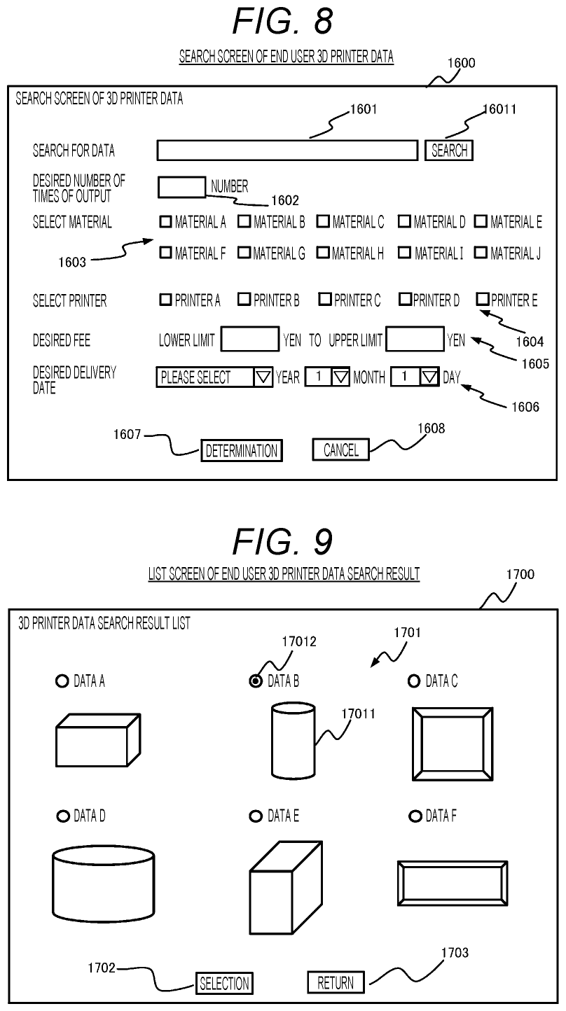

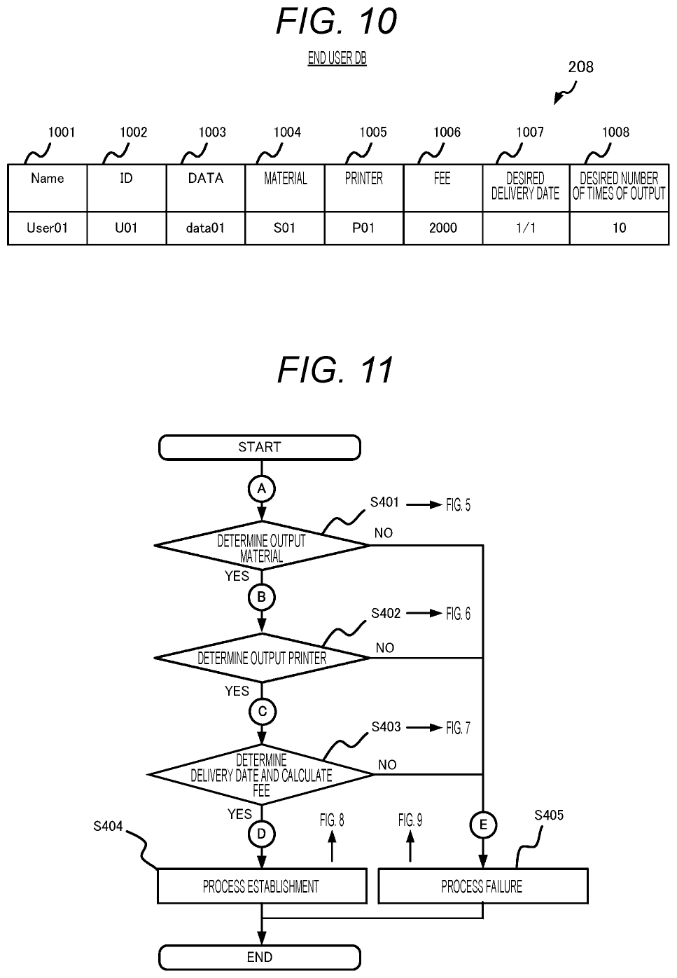

FIG. 7 illustrates a data configuration example of the output agency DB 209 according to the present embodiment. The output agency DB 209 is a database in which the registration information on the output agency service provided by the output agency is stored.

Specifically, the output agency DB 209 is an aggregate of records in which values such as a name 1103 of the material that can be used to output the molded object based on the 3D printer data in the output agency, a name 1104 of the type of 3D printers 45 that can be used to output the molded object based on the 3D printer data in the output agency, a fee 1105 for outputting one molded object when the molded object is output based on the 3D printer data by the 3D printer indicated by the name 1104 of the 3D printer using the material indicated by the name 1103 of the material, and a maximum number 1106 of the molded object that can be output per day when the molded object is output based on the 3D printer data by the 3D printer indicated by the name 1104 of the 3D printer using the material indicated by the name 1103 of the material are associated with a name 1101 and a user ID 1102 of the output agency terminal 40 as keys.

Return to the description of the sequence of FIG. 3. After executing S303 and S304 described above, the end user terminal 20 requests the data management server 200 to execute a search request for the 3D printer data corresponding to the molded object desired by the end user and a registration request of various desired conditions regarding the output of the molded object (S305).

In this case, the data management server 200 accepts the search request from the end user terminal 20 via a search screen 1600 illustrated in FIG. 8, returns the information on the 3D data stored in the 3D data DB 207 to the end user terminal 20, and accepts the selection by the end user via the end user terminal 20.

FIG. 8 is a diagram illustrating an example of the search screen 1600 transmitted to the above-described end user terminal 20. In this search screen 1600, the end user operating the end user terminal 20 can accept the search of the 3D printer data of the molded object to be output, the number of times of output of the molded object, the type of materials to be used for the output of the molded object and the 3D printers 45, and setting of a desired fee or a desired delivery date.

Such a search screen 1600 includes an input form 1601, which accepts a keyword of the molded object that the end user desires to output. The data management server 200 accepts a keyword input on the input form 1601 on the search screen 1600, accepts a press of a search button 16011, searches for 3D printer data associated with a target keyword in the 3D data DB 207, returns a list screen 1700 (FIG. 9) of the hit 3D printer data to the end user terminal 20, and transitions the screen.

FIG. 9 illustrates the list screen 1700 of the 3D printer data. On this list screen 1700, the data management server 200 can search the 3D data DB 207 based on the keyword accepted in the input form 1601, and display the search result of the corresponding 3D printer data in a list.

The list screen 1700 includes a display field 1701 for the hit 3D printer data included in the search result. As illustrated, the 3D printer data displayed here further includes a radio button 17012, which accepts the selection in addition to an image 17011 indicating the shape of the molded object.

In addition, the list screen 1700 includes a selection button 1702, which reflects the name of the 3D printer data to the input form 1601 on the search screen 1600, with regard to the acceptance of the selection of the 3D printer data through a check of the radio button 17012 among the 3D printer data displayed in the above-described display field 1701. When this selection button 1702 is pressed, the screen transitions to the search screen 1600.

At this time, in the 3D printer data selected by the end user on the list screen 1700, the information on the available material is reflected in a default display of the check box 1603, and the information on the available 3D printer 45 is reflected in the default display of the check box 1604, and a name is displayed as a selection item.

In addition, the list screen 1700 includes a return button 1703, which accepts an instruction to transition the screen to the search screen 1600. By pressing a return button 1703, the selection of the 3D printer data by the end user on the list screen 1700 is not reflected on the search screen 1600.

The end user terminal 20 displays the list screen 1700 of the 3D printer data described above accepts the selection of the 3D printer data by the end user, and transitions the screen to the search screen 1600. In this case, the input form 1601 of the search screen 1600 displays the name of the 3D printer data checked and selected by the end user using the radio button 17012 of the list screen 1700. When the 3D printer data is not hit by the search, an effect indicating that there is no hit is displayed on a transition destination screen.

In addition to the above-described input form 1601 described above, the above-described search screen 1600 includes an input form 1602, which accepts the input of the number of molded objects that the to be output based on 3D printer data from the end user, a check box 1603, which selectively displays the outputtable materials that is registered for the hit 3D printer data in the data search, a check box 1604, which selectively displays the outputtable 3D printer 45 that is registered for the hit 3D printer data in the data search, an input form 1605, which accepts lower and upper limit fees of a desired fee that the end user allows to pay, and a combo box 1606, which accepts a date on which the end user wants to deliver the molded object.

In addition, the search screen 1600 includes a determination button 1607, which accepts an instruction to register the contents input and accepted in the input form 1601, the input form 1602, the check box 1603, the check box 1604, the input form 1605, and the combo box 1606 described above in the data management server 200. By pressing the determination button 1607, the contents input and accepted in the input form 1601, the input form 1602, the check box 1603, the check box 1604, the input form 1605, and the combo box 1606 described above are transmitted to the data management server 200 and registered in the end user DB 208 (FIG. 10).

In addition, the search screen 1600 includes a cancel button 1608, which accepts an instruction to clear the contents input and accepted in the input form 1601, the input form 1602, the check box 1603, the check box 1604, the input form 1605, and the combo box 1606 described above. By pressing the cancel button 1608, on the search screen 1600, the contents input and selected in each of the input form 1601, the input form 1602, the check box 1603, the check box 1604, the input form 1605, and the combo box 1606 are cleared.

FIG. 10 illustrates the data configuration of the end user DB 208, which registers the contents input and selected on the above-described search screen 1600.

Specifically, the end user DB 208 uses a name 1001 and a user ID 1002 of the end user as keys, and is an aggregate of records associated with each value of a name 1003 of the 3D printer data desired by the end user, a name 1004 of the material used to output the molded object based on the 3D printer data, a name 1005 of the type of 3D printers 45 that can be used to output the molded object based on the 3D printer data, a desired amount 1006 that the end user allows to pay, a desired delivery date 1007 of the molded object desired by the end user, and the number 1008 of molded object desired by the end user.

Return to the description of the sequence of FIG. 3. Subsequently, the data management server 200 performs matching process based on the contents registered by the end user terminal 20 in S305, the contents registered in advance by the data provider terminal 30 in S303, and the contents registered by the output agency terminal 40 in S304 (S306).

Although details of the matching process will be described later, the matching process includes steps in the matching unit 202 and the various calculation unit 204. The matching process is executed when the end user terminal 20 searches for the 3D printer and registers the desired conditions in S305.

When the matching is established in the matching process in S306 described above, the data management server 200 notifies the end user terminal 20 of the matching establishment result (S307). This notification includes information on the fee accompanied by the use of the 3D printer data and the delivery date of the molded object.

In addition, when the matching is established in the matching process in S306 described above, the data management server 200 transmits an output request for the 3D printer data desired by the end user to the output agency terminal 40 of the output agency specified by the matching (S308).

Here, the transmitted contents include encrypted 3D printer data used in the corresponding 3D printer 45 of the output agency, a secret key for decrypting the 3D printer data, and the number of times of output of the molded object based on the 3D printer data, information on the material to be used, a type of 3D printers 45, a delivery date of the molded object, a fee for the output of the molded object based on the 3D printer data, and end user information.

When the data management server 200 transmits the output request in S308 described above, it is preferable that the information on the number of times of output of the molded objects is encrypted with the secret key. The number of times of output of the molded object is sensitive information that directly affects the usage fee of the corresponding 3D printer data, and therefore needs to be prevented from tampering.

Subsequently, when the matching is established in the matching process in S306 described above, the data management server 200 transmits, to the data provider terminal 30, the effect that the 3D printer data provided by the data provider are used and information on a fee paid to the data provider (S309).

In addition, when the matching fails in the matching process in S306 described above, the data management server 200 transmits information on the matching failure to the end user terminal 20 (S311).

Note that S307, S308, S309, and S311 described above are executed when each process is executed by the matching unit 202 and the various calculation unit 204 in S306 and the results are determined.

Further, after accepting the output request of the 3D printer data in S308, the output agency terminal 40 decrypts the encrypted 3D printer data with the secret key, transmits the decrypted 3D printer data to the 3D printer 45, and outputs the molded object according to the delivery date desired by the end user (S310).

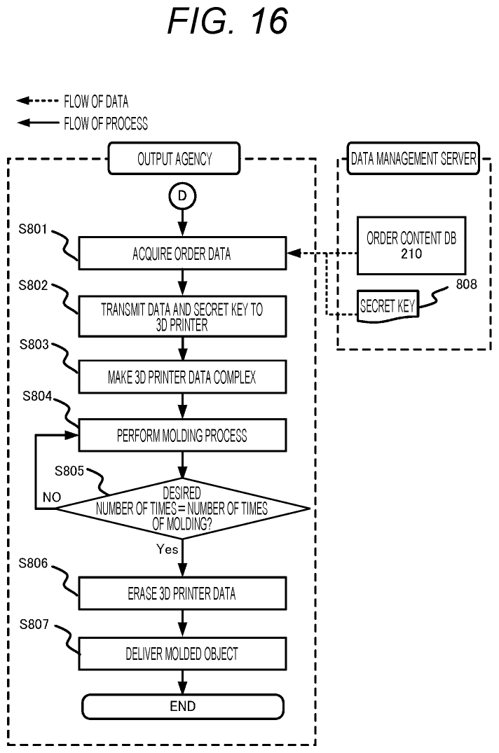

In the output agency, the above-described molded object is output by the 3D printer 45 and then addressed to the end user. Details of each process in the output agency will be described below with reference to FIG. 16.

### FLOW EXAMPLE 1

FIG. 11 shows a flow for the matching process (S306) in the data management server 200. In this case, the data management server 200 executes the matching on the material used to output the molded object based on the 3D printer data, according to S305 in the sequence of FIG. 3 (S401).

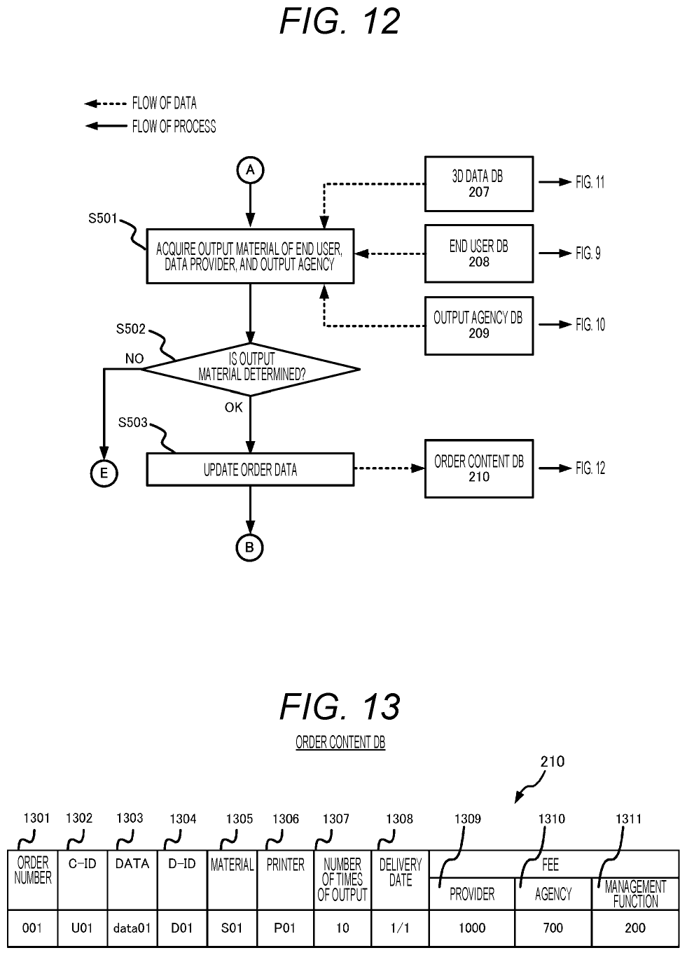

This matching uses the information on the desired material accepting the designation from end user terminal 20 in S305 described above, and is a process of determining whether the output of the molded object using the material is possible at the output agency or whether the material is a material that can be used in the 3D printer data provided by the data provider. By doing so, it is possible to select a material to be used to output the 3D printer data. The detailed flow of the matching process on this material will be described below with reference to FIG. 12.

Next, the data management server 200 executes the matching process on the type of 3D printers 45 used to output the molded object based on the 3D printer data, according to the establishment of the matching process on the material in S401 described above (S402).

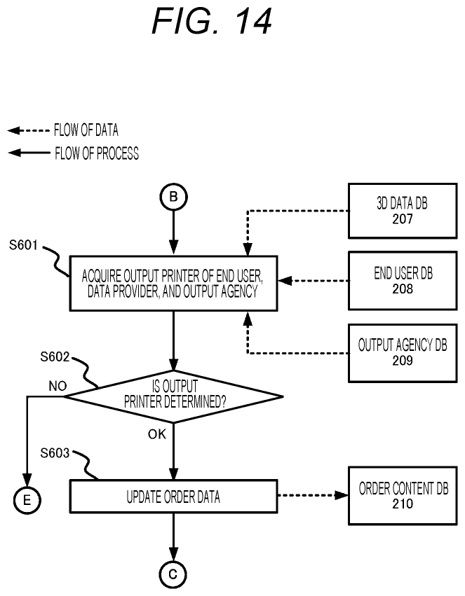

The matching uses the information on the desired 3D printer 45 accepting the specification from the end user terminal 20 in S305 described above, and is a process of determining whether the 3D printer data can be output by the 3D printer 45 at the output agency or whether the type of 3D printers 45 selected by the end user is a type that can output the 3D printer data provided by the data provider. By doing so, it is possible to select the type of 3D printers 45 used to output the 3D printer data. The detailed flow of the matching process on the 3D printer 45 will be described below with reference to FIG. 14.

Subsequently, the data management server 200 executes matching on the delivery date of the molded object desired by the end user and the usage fee of the 3D printer data, according to the establishment of the matching process on the 3D printer 45 in S402 described above (S403).

The matching is a process of calculating the required delivery date of the molded object and comparing the calculated delivery date with the delivery data desired by the end user based on the information on the number of times of output of the desired molded object registered in the data management server 200 by the end user terminal 20 in S305 and the information on the output agency service registered in the data management server by the output agency terminal 40 in S304. By doing so, the delivery date of the molded object output by the output agency is determined.

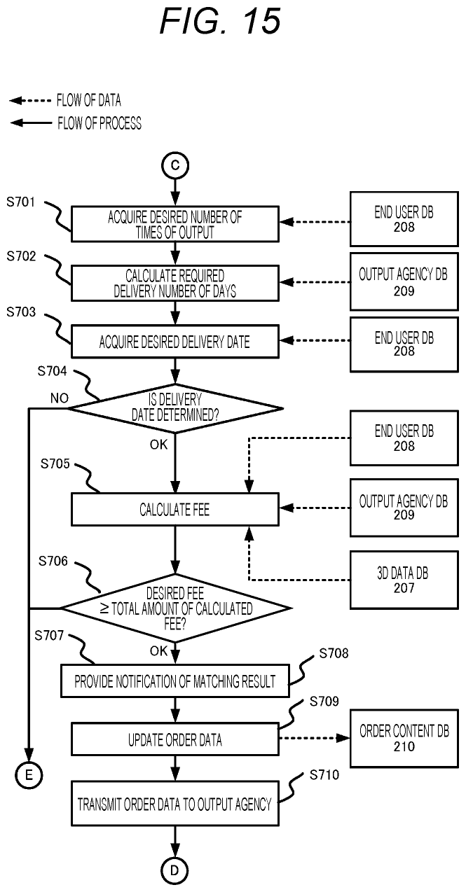

In addition, the data management server 200 in S403 described above performs a process of comparing a sum of the usage fee for the 3D printer data registered in the data management server 200 by the data provider terminal 30 in S303 and the fee for the output service of the 3D printer data registered in the data management server 200 by the output agency terminal 40 in S304, which are registered in the data management server 200 by the end user terminal 20 in S305, with a fee to be paid when using and outputting the 3D printer data, and calculating a fee paid by the end user terminal 20. By doing so, the fee that the end user pays to the output agency and the like is determined. A detailed flow of this calculation process will be described below with reference to FIG. 15.

In S401 described above, the matching process on the material used to output the 3D printer data, in S402, the matching process on the type of 3D printers 45 is established, and in S403, the data management server 200 transmits, to the end user terminal 20, the information on the material used to output the determined 3D printer data, the type of 3D printers 45 to be used, the delivery date of the molded object, and the payment fee, according to the determination on the delivery date of the molded object to be output and the fee paid by the end user based on the 3D printer data (S404). A detailed flow of this process will be described below with reference to FIG. 16.

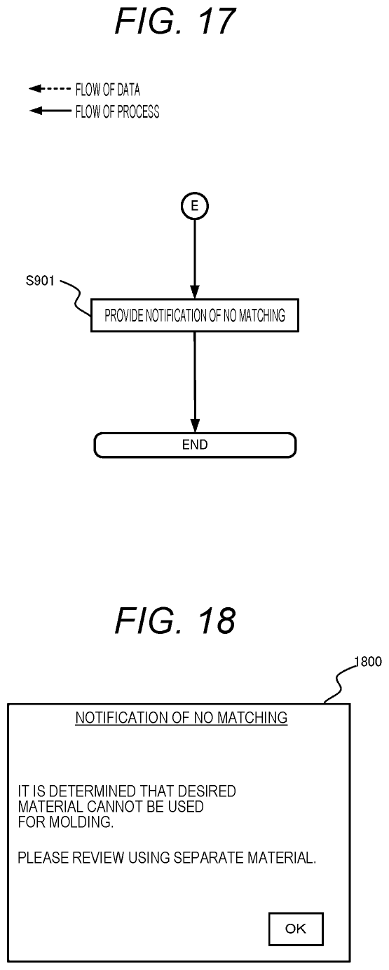

If the matching process in S401, S402, and S403 described above is not established, the data management server 200 transmits the information on the matching failure to the end user terminal 20 (S405), and the process ends. A detailed flow of this processing will be described below with reference to FIG. 17.

### FLOW EXAMPLE 2

FIG. 12 shows a process in which the data management server 200 uses the 3D data DB 207, the end user DB 208, and the output agency DB 209 to match materials used to output the molded object based on the 3D printer data. Hereinafter, the processing steps will be described.

In this case, first, the data management server 200 acquires, from the end user DB 208, data on the material used to output the molded object accepted from the end user terminal 20 in S305 described above (S501). Further, the data management server 200 in S501 searches for the information on the corresponding material from the 3D data DB 207 and the output agency DB 209 using the data on the material acquired from the end user DB 208 as a key (S501).

Next, the data management server 200 determines that the data on the material used as the key in S501 described above, that is, the material desired by the end user matches the search result in the 3D data DB 207 and the output agency DB 209, that is, the material specified in the 3D printer data and the outputtable material in the 3D printer 45 of the output agency (S502).

As a result of the determination in S502 described above, if the data on the material used as the key in S501 described above matches the material indicated by the search results in the 3D data DB 207 and the output agency DB 209 (S502: OK), the data management server 200 determines the corresponding material as the material used to output the 3D printer data and registers the material information in the order content DB 210 as order data (S503).

On the other hand, as a result of the determination in S502 described above, when the data on the material used as the key in S501 described above does not match the material indicated by the search results in the 3D data DB 207 and the output agency DB 209 (S502: NO), the data management server 200 shifts the process to S901 (described later) in FIG. 17.

FIG. 13 illustrates a data configuration example of the order content DB 210 in which the order data of the end user are stored. The order content DB 210 is an aggregate of records in which each value of a C-ID 1302 that is identification information of the end user who is an orderer, a name 1304 of the 3D printer data selected by the end user, D-ID 1304 that is identification information of the 3D printer data, a name 1305 of the material used to output the molded objects based on the 3D printer data, a name 1306 of the 3D printer 45 used to output the molded object based on the 3D printer data, the number 1307 of molded object desired by the end user, a delivery date 1308 of the molded object desired by the end user, a 3D printer data usage fee 1309 paid to the data provider among fees paid by the end user, a molding agency fee 1310 paid to the output agency, and a usage fee 1311 of the data management server 200 is associated with an order number 1301 that uniquely specifies the confirmed order as a key.

### FLOW EXAMPLE 3

FIG. 14 is a flow in which the data management server 200 uses the 3D data DB 207, the end user DB 208, and the output agency DB 209 to match the 3D printers 45 used to output the 3D printer data. Hereinafter, the processing steps will be described.

In this case, first, the data management server 200 acquires, from the end user DB 208, the data on the type of 3D printers 45 used to output the 3D printer data included in all the conditions registered in the data management server 200 by the end user terminal 20 in S305 described above (S601). The data management server 200 in S601 searches for the information on the type of 3D printers 45 from the 3D data DB 207 and the output agency DB using the data on the type of 3D printers 45 acquired from the end user DB 208 as a key.

Subsequently, the data management server 200 determines whether the data used as a key in S601 described above, that is, the type of 3D printers 45 desired by the end user match the search result in 3D data DB 207 and output agency DB 209, that is, the type of 3D printers 45, which can be used to output the 3D printer data and can be used in the output agency (S602).

As a result of the determination in S602 described above, when the type of 3D printers 45 used as a key in S601 described above matches the type of 3D printers 45 indicated by the search results in 3D data DB 207 and output agency DB 209 (S602: OK), the data management server 200 determines the type of 3D printers 45 as the type of 3D printers 45 used to output the 3D printer data, and uses the information on the types of 3D printer 45 as the order data of the end user terminal 20 to update the existing record of the order content DB 210 (stored in S503) (S603).

On the other hand, as a result of the determination in S602 described above, when the data on the type of 3D printers 45 used as the key in S601 described above does not match the type of 3D printers 45 indicated by the search results in the 3D data DB 207 and the output agency DB 209 (S602: NO), the data management server 200 shifts the process to S901 (described later) in FIG. 17.

### FLOW EXAMPLE 4

FIG. 15 is a flow of calculating, by the data management server 200, the delivery date of the molded object and the fee paid by the end user in consideration of the number of times of output desired by the end user and the fee to be paid when using the 3D printer data, the condition of the output agency service registered by the output agency in S304, and the use condition of the 3D printer data registered by the data provider in S303. Hereinafter, the processing steps will be described.

First, the data management server 200 acquires the desired number of times of output of the 3D printer data registered by the end user terminal 20 in S305 from the end user DB 208, according to the update of the order data in S603 described above (S701).

Next, the data management server 200 calculates the number of days required for delivery of the molded object from the number of molded objects which can be output per day by the combination of the material used to output the 3D printer data and the type of 3D printers 45 registered by the output agency terminal 40 in S304 (S702).

Since the material used to output the 3D printer data registered by the end user terminal 20 in S305 or the types of 3D printers 45 used are established by the matching illustrated in FIGS. 12 and 14, the data management server 200 uses the combination of the material and the type of 3D printers 45 as the key and performs the search in the output agency DB 209. By multiplying the desired number of molded objects output by the end user and the number of molded objects that can be output per day by the combination of the material and the type of 3D printers 45, the number of days required for delivery of the molded object can be calculated.

In addition, the data management server 200 acquires the desired delivery date of the molded object registered by the end user terminal 20 in S305 from the end user DB 208, according to the completion of the calculation of the required number of days for delivery of the molded object (S703).

In addition, after acquiring the desired delivery date of the molded object, the data management server 200 compares the required delivery date of the molded object calculated in S702 described above with the desired delivery date of the molded object acquired in S703 (S704).

When the required delivery date of the molded object is earlier than the delivery date of the molded object desired by the end user (S704: OK), the data management server 200 specifies the required delivery date as the delivery date. On the other hand, when the required time for delivery of the molded object is later than the delivery date of the molded object desired by the end user (S704: NO), the data management server 200 determines that the matching is not established, and the process shifts to S901 (described later) in FIG. 17.

Next, the data management server 200 calculates a fee paid by the end user when using the 3D printer data, according to the determination of the delivery date of the molded object in S704 described above (S705).

The breakdown of the fee paid by the end user is a data usage fee paid to the data provider, a 3D printer data molding request fee paid to the output agency, and the usage fee of the data management server paid to the data management server 200.

Here, the data management server 200 acquires, from the end user DB 208, a value of a fee that allows the payment when using the 3D printer data registered by the end user in S305. Then, the data management server 200 acquires, from the output agency DB 209, the information on the fee per one molded object by the combination of the type of 3D printers 45 registered by the output agency in S304 and the material used to output the 3D printer data, and multiplies the fee by the desired number of outputs registered by the end user in S305 to calculate the 3D printer data molding request fee to be paid to the output agency.

In addition, the data management server 200 acquires the fee per one molded object created from the 3D printer data registered by the data provider in S303 from the 3D data DB 207 and multiplies the acquired fee by the desired number of times of output of the molded object for the end user to calculate the data usage fee to be paid to the data provider.

Further, the data management server 200 adds up the above-mentioned 3D printer data molding request fee and data usage fee and the usage fee of the data management server 200, and determines the fee to be paid by the end user. In the following, the fee to be paid by the end user is specified as the total amount.

Note that the usage fee of the data management server 200 is uniform regardless of the number of times of output of the molded objects or the material used for the output and the type of 3D printers 45 based on the 3D printer data.

Subsequently, the data management server 200 executes the matching process based on the fee that the end user allows for payment, that is, the desired amount, and the total amount determined in S705 described above, when the total amount is determined in S705 described above. In this case, the data management server 200 compares the desired amount acquired in S705 with the total amount, and if the total amount falls below the desired amount (S706: OK), the fee to be paid by the end user is specified as the total amount. On the other hand, when the total amount exceeds the desired amount (S706: NO), the data management server 200 determines that the matching is not established, and shifts the process to S901 (described later) in FIG. 17.

Subsequently, the data management server 200 notifies the end user terminal 20 of each information on the delivery date of the molded object and the payment fee, when the fee paid by the end user is determined in S706 described above (S707).

Further, according to the notification to the end user terminal 20 in S707 described above, the data management server 200 uses the fee paid by the end user and the delivery date of the molded object as the order data, and updates the correspondence record in the order content DB 210 with the contents (S708).

Further, after updating the order data in the order content DB in S708 described above, the data management server 200 acquires the order data from the order content DB 210 and transmits the acquired order data to the output agency terminal 40 (S710). The order data thus transmitted includes the 3D printer data used to output the molded object, the material used to output the molded object in the 3D printer 45, the type of 3D printers 45, the number of times of output of the molded object based on the 3D printer data, the delivery date of the molded object, and the 3D printer data molding request fee paid to the output agency.

### FLOW EXAMPLE 5

FIG. 16 is a flow illustrating the output processing of the molded object in the output agency terminal 40 when the data management server 200 transmits the 3D printer data to the output agency terminal 40 through the determination of the order data by the matching process. As a result, the output agency can output the molded object based on the 3D printer data.

Here, the processing of the data management server 200 only transmits order contents (including the 3D printer data and the secret key) to the output agency terminal 40. The output processing of the molded object based on the 3D printer data is processing performed by the output agency terminal 40 and the 3D printer 45 connected thereto. Hereinafter, the processing steps will be described.

First, the output agency terminal 40 receives the order data transmitted from the data management server 200 in S710 described above, and acquires 3D printer data and a secret key 808 for decrypting the 3D printer data from the order data (S801).

When the above-described 3D printer data are registered in the data management server 200 from the data provider terminal 30 (S303), the 3D printer data is encrypted with a predetermined key (for example, public key) in the data management server 200, that is, are encrypted 3D printer data. The encrypted 3D printer data requires a secret key 808 for the decryption.

After accepting the order data in S801 described above and acquiring necessary data, the output agency terminal 40 transmits the 3D printer data and the secret key 808 to the 3D printer 45, which is communicatively connected (S802). The 3D printer 45 is sold from a printer manufacturer to an output agency.

The type of 3D printers 45, which use the output agency terminal 40 as a transmission target of the 3D printer data or the secret key 808 in S802, that is, the type of 3D printers 45 used to output the molded object according to the order of the end user is a model of the 3D printer 45 registered in the order data acquired in S801 described above.

The output agency terminal 40 transmits the 3D printer data and the secret key 808 to the 3D printer 45 in S802 described above, and then instructs the module 46 of the 3D printer 45 to decrypt the 3D printer data using the secret key 808 and attempts to decrypt the 3D printer data (S803). In this S803, the output agency terminal 40 decrypts and acquires the information on the number of times of output of the molded object based on the 3D printer data with the secret key 808. The output agency terminal 40 sets the information on the number of times of output thus obtained in the module 46 of the 3D printer 45.

Subsequently, the output agency terminal 40 spools the decrypted 3D printer data in the 3D printer 45, and causes the 3D printer 45 to output the molded object based on the 3D printer data (S804). The material used for molding by the 3D printer 45 is a material specified in the order data acquired from the data management server 200 in S801 described above.

Since the module 46 of the 3D printer 45 described above is a function of controlling the output of the molded object in the 3D printer 45, the number of times of output of the molded object in the 3D printer 45 is counted with the output of the molded object, and it is monitored whether the count value reaches the number of times of output (desired number of the end user) set by being decrypted from the order data.

Based on the monitoring result of the number of times of output, the module 46 of the 3D printer 45 determines whether the number of times of output of the molded object described above reaches the desired number of times (S805). As a result of the determination, when the number of times of output reaches the desired number of times (S805: Yes), the module 46 executes the erase process of the 3D printer data (S806) and notifies the output agency terminal 40 of the effect.

Note that since the information on the desired number of times is stored in the module 46 by S803, when the number of times of output of the molded object based on the 3D printer data reaches the desired number of times, the data can be automatically erased.

It may be assumed that the output agency terminal 40 instructs the module 46 to erase the 3D printer data. In this case, the module 46 notifies the output agency terminal 40 of the above-described monitoring result, and the output agency terminal 40 executes the erase process of the 3D printer data based on this monitoring result.

After the molding is performed by the desired number of times of the end user and the erase of the 3D printer data is completed, the output agency terminal 40 executes the process of delivering the molded object addressed to the end user (S807) and the process ends. For this delivery process, it can be assumed that the output agency terminal 40 electronically performs a delivery request for the molded object to the corresponding end user on a system of a transport operator that is contracted in advance.

### FLOW EXAMPLE 6

FIG. 17 illustrates a process executed in accordance with S405 in the flow of FIG. 11, and a process of transmitting, by the data management server 200, the information on the matching failure to the end user terminal 20. Hereinafter, the processing steps will be described.

In this case, when the matching is not established on a material in S502 in the flow of FIG. 12, the data management server 200 transmits, to the end user terminal 20, a notification 1800 (FIG. 18) that the material registered by the end user cannot be used to output the desired molded object (S901).

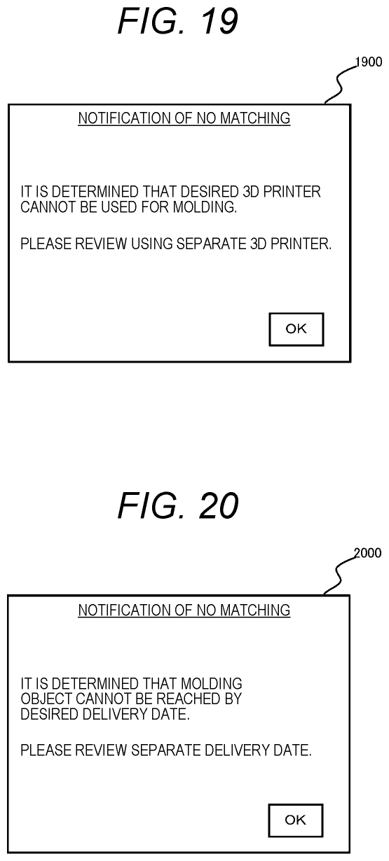

Similarly, when the matching is not established on the 3D printer 45 in S602 in the flow of FIG. 14, the data management server 200 transmits, to the end user terminal 20, a notification 1900 (FIG. 19) that the 3D printer 45 registered by the end user cannot be used to output the desired molded object (S901).

Similarly, when the matching is not established for the delivery date in S704 in the flow of FIG. 15, the data management server 200 transmits, to the end user terminal 20, a notification 2000 (FIG. 20) that the delivery cannot be made up to the delivery date of the molded object registered by the end user (S901).

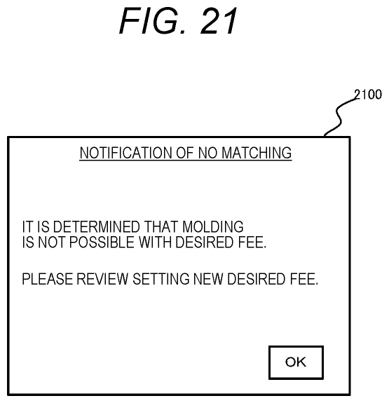

Similarly, when the matching is not established for a fee in S706 in the flow of FIG. 15, the data management server 200 transmits, to the end user terminal 20, a notification 2100 (FIG. 21) that the molded object cannot be created with the desired fee registered by the end user (S901).

Although the best mode for carrying out the present invention has been specifically described above, the present invention is not limited to this, and various modifications can be made without departing from the scope of the invention.

According to the present invention, it is possible to efficiently execute the matching between the parties involved in the output business of the molded object by the 3D printer while accurately considering each condition between the parties.

At least the following matters will be clarified by the description of the present specification. That is, in the matching support device according to the present embodiment, when the agency is specified, the computing device may execute a data determination process of specifying a presence of 3D printer data necessary for output of a molded object defined under a condition of the end user in the 3D printer data accepted from the provider and stored in the storage device, a material determination process of specifying the presence of the material of the molded object defined under the condition of the end user and an outputtable material defined under a condition of the agency in an outputtable material specified by the 3D printer data specified by the data determination process, a printer determination process of specifying the presence of the 3D printer defined under the condition of the end user and an outputtable printer specified under the condition of the agency in the outputtable printer specified by the 3D printer data specified by the data determination process, and a cost determination process of calculating a fee for molding by the 3D printer specified in the printer determination process using the 3D printer data specified in the data determination process and specifying the presence of an agency whose fee falls below an allowable cost specified under the condition of the end user for the molded object specified under the condition of the end user based on the specification of the molding fee among the conditions of the agency and the specification of the data usage fee among the conditions of the provider, and finally specify the agency by the cost determination process.

According to this, it is possible to specify an agency that can make an order with a matching content regarding the material of the molded object, the 3D printer, and the fee which are the conditions specified by the end user, and present the specified agency to the end user. According to the invention, the matching between the parties involved in the output business of the molded object by the 3D printer can be performed efficiently while accurately considering each condition between the parties.

Further, in the matching support device of the present embodiment, when the agency is specified, the computing device may calculate a delivery date on which the molded object is output and provided to the end user by the outputtable printer specified in the printer determination process using the outputtable material specified in the material determination process based on the desired number of times of output of the molded objects defined under the condition of the end user and the working time defined under the condition of the agency, further execute a delivery date determination process of specifying the presence of agencies in which delivery date is earlier than a receipt time of the molded object defined under the condition of the end user, and finally specify an agency whose fee falls below the allowable cost specified under the condition of the end user among the agencies in which the delivery date is earlier than the receipt time of the molded object.

As a result, it is possible to specify an agency that can make an order with a matching content regarding the material of the molded object, the 3D printer, the fee, and the delivery date which are the conditions specified by the end user, and present the specified agency to the end user. Furthermore, the matching between the parties involved in the output business of the molded object by the 3D printer can be performed efficiently while more accurately considering each condition between the parties.

In addition, in the matching support device of the present embodiment, the computing device may further execute a process of outputting a notification of a matching failure to the terminal of the end user when the presence corresponding to any of the data determination process, the material determination process, the printer determination process, the cost determination process, and the delivery date determination process cannot be specified.

As a result, it is possible to quickly notify that an order with contents that match the conditions specified by the end user is not possible and cause the end user to avoid wasteful work and waiting time. Furthermore, the matching between the parties involved in the output business of the molded object by the 3D printer can be performed further efficiently while accurately considering each condition between the parties.

In addition, in the matching support device of the present embodiment, the computing device may further execute a process of determining the specified contents as the order information by the end user and storing the specified contents in the storage device when the 3D printer data, the material, the 3D printer, the fee, the delivery date, and the agency necessary for the output of the molded object desired by the end user are specified through the data determination process, the material determination process, the printer determination process, the cost determination process, and the delivery date determination process.

As a result, it is possible to determine an order with the contents matched for the material of the molded object, the 3D printer, the fee, and the delivery date which are the conditions specified by the end user, and present and manage the specified order to the end user. Furthermore, the matching between the parties involved in the output business of the molded object by the 3D printer can be performed efficiently while accurately considering each condition between the parties.

Further, in the matching support device according to the present embodiment, the computing device may accept the 3D printer data from the provider via the predetermined device, execute the encryption process on the 3D printer data, and further execute a process of storing the encrypted 3D printer data in the storage device.

As a result, the 3D printer data obtained from the 3D printer data provider can be securely managed, and can be securely distributed to the corresponding agency as the order information is determined. From the provider, the 3D printer data provided by the provider will be less likely to be leaked, so the provision of the 3D printer data is promoted, and the variation in the 3D printer data which is desired by the end user and can be used by the agency will be expanded. Furthermore, the matching between the parties involved in the output business of the molded object by the 3D printer can be performed efficiently while accurately considering each condition between the parties.

Further, in the matching support device according to the present embodiment, the computing device may further execute a process of linking the encrypted 3D printer data and a secret key for decrypting the encrypted 3D printer data to order information as the order information is determined and transmitting the order information to the agency terminal.

As a result, the 3D printer data obtained from the provider of the 3D printer data can be securely distributed to the corresponding agency as the order information is determined. From the provider, the 3D printer data provided by the provider will be less likely to be leaked, so the provision of the 3D printer data is promoted, and the variation in the 3D printer data which is desired by the end user and can be used by the agency will be expanded. Furthermore, the matching between the parties involved in the output business of the molded object by the 3D printer can be performed efficiently while accurately considering each condition between the parties.

In addition, the matching support system according to the present embodiment may further include a module providing device which includes a storage device storing a module for decrypting the encrypted 3D printer data using a secret key to make a moldable state and erasing the 3D printer data after molding is performed by the specified number of times of output, and a computing device distributing the module to a 3D printer used in the agency, and a 3D printer which includes a storage device storing the module distributed from the module providing device and a computing device calling and executing the module, decrypting the encrypted 3D printer data using the secret key to make the moldable state, and erasing the 3D printer data after the molding is performed by the number of times of output specified by the order information when order information on the output of the molded object of the end user determined as the agency is specified, the encrypted 3D printer data used to output the molded object at the agency, the secret key for decrypting the encrypted 3D printer data are acquired from the matching support device through the terminal of the agency.

### REFERENCE SIGNS LIST

10 network
20 end user terminal
30 data provider terminal
40 output agency terminal
45 3D printer
46 module
50 printer manufacturer terminal
60 module provider manufacturer terminal
100 matching support system
200 data management server (matching support device)
201 computing device
202 matching unit
203 various registration unit
204 various calculation unit
205 result display unit
206 storage device
207 3D data DB
208 end user DB
209 output agency DB
210 order content DB
211 memory
212 communication device
220 program

1. A matching support device, comprising:
a storage device which stores predetermined conditions specified for an output of a molded object by each of an agency of the output of the molded object, a provider of 3D printer data, and an end user wanting the molded object that are parties of an output business of the molded object by a 3D printer; and
a computing device which compares each condition of the party at least based on the respective contents of the molded object, the 3D printer, and cost which are specified under a condition of the end user, uses the 3D printer data necessary for the output of the molded object, specifies the agency satisfying the condition of the end user, and outputs information on the agency to a predetermined device.

2. The matching support device according to claim 1, wherein when the agency is specified,
the computing device executes
a data determination process of specifying a presence of 3D printer data necessary for output of a molded object defined under a condition of the end user in the 3D printer data accepted from the provider and stored in the storage device,
a material determination process of specifying the presence of the material of the molded object defined under the condition of the end user and an outputtable material defined under a condition of the agency in an outputtable material specified by the 3D printer data specified by the data determination process,
a printer determination process of specifying the presence of the 3D printer defined under the condition of the end user and an outputtable printer specified under the condition of the agency in the outputtable printer specified by the 3D printer data specified by the data determination process, and
a cost determination process of calculating a fee for molding by the 3D printer specified in the printer determination process using the 3D printer data specified in the data determination process and specifying the presence of an agency whose fee falls below an allowable cost specified under the condition of the end user for the molded object specified under the condition of the end user based on the specification of the molding fee among the conditions of the agency and the specification of the data usage fee among the conditions of the provider, respectively and
finally specifies the agency by the cost determination process.

3. The matching support device according to claim 2, wherein when the agency is specified,
the computing device
calculates a delivery date on which the molded object is output and provided to the end user by the outputtable printer specified in the printer determination process using the outputtable material specified in the material determination process based on the desired number of times of output of the molded objects defined under the condition of the end user and a working time defined under the condition of the agency, further executes a delivery date determination process of specifying the presence of agencies in which the delivery date is earlier than a receipt time of the molded object defined under the condition of the end user, and
finally specifies an agency whose fee falls below the allowable cost specified under the condition of the end user among the agencies in which the delivery date is earlier than the receipt time of the molded object.

4. The matching support device according to claim 3, wherein
the computing device further executes a process of outputting a notification of a matching failure to the terminal of the end user when the presence corresponding to any of the data determination process, the material determination process, the printer determination process, the cost determination process, and the delivery date determination process is not specified.

5. The matching support device according to claim 3, wherein
the computing device further executes a process of determining the specified contents as the order information by the end user and storing the specified contents in the storage device when the 3D printer data, the material, the 3D printer, the fee, the delivery date, and the agency necessary for the output of the molded object desired by the end user are specified through the data determination process, the material determination process, the printer determination process, the cost determination process, and the delivery date determination process.

6. The matching support device according to claim 5, wherein
the computing device accepts the 3D printer data from the provider via the predetermined device, executes the encryption process on the 3D printer data, and further executes a process of storing the encrypted 3D printer data in the storage device.

7. The matching support device according to claim 6, wherein
the computing device further executes a process of linking the encrypted 3D printer data and a secret key for decrypting the encrypted 3D printer data to order information as the order information is determined and transmitting the order information to the agency terminal.

8. A matching support system, comprising a matching support device which includes
a storage device storing predetermined conditions specified for an output of a molded object by each of an agency of the output of the molded object, a provider of 3D printer data, and an end user wanting the molded object that are parties of an output business of the molded object by a 3D printer, and
a computing device comparing each condition of the party at least based on the respective contents of the molded object, the 3D printer, and cost which are specified under a condition of the end user, using the 3D printer data necessary for the output of the molded object, specifying the agency satisfying the condition of the end user, and outputting information on the agency to a predetermined device.

9. The matching support system according to claim 8, further comprising:
a module providing device which includes a storage device storing a module for decrypting encrypted 3D printer data using a secret key to make a moldable state and erasing the 3D printer data after molding is performed by the specified number of times of output, and a computing device distributing the module to a 3D printer used in the agency; and
a 3D printer which includes a storage device storing the module distributed from the module providing device and a computing device calling and executing the module, decrypting the encrypted 3D printer data using the secret key to make the moldable state, and erasing the 3D printer data after the molding is performed by the number of times of output specified by order information when the order information on the output of the molded object of the end user determined as the agency is specified, the encrypted 3D printer data used to output the molded object at the agency, and the secret key for decrypting the encrypted 3D printer data are acquired from the matching support device through the terminal of the agency.

10. A matching support method, comprising:
allowing an information processing device including a storage device which stores predetermined conditions specified for an output of a molded object by each of an agency of the output of the molded object, a provider of 3D printer data, and an end user wanting the molded object that are parties of an output business of the molded object by a 3D printer to
compare each condition of the party at least based on the respective contents of the molded object, the 3D printer, and cost which are specified under a condition of the end user, use the 3D printer data necessary for the output of the molded object, specify the agency satisfying the condition of the end user, and output information on the agency to a predetermined device.
